(19) United States
(12) Patent Application Publication
(10) Pub. No.: US 2009/0166142 A1
(43) Pub. Date: Jul. 2, 2009

(54) TUNNEL TYPE POWER GENERATING APPARATUS AND METHOD OF GENERATING POWER USING THE SAME

(76) Inventors: Min Suk Hyun, Seoul (KR); Hyung Joo Kim, Seoul (KR); Chang Ho Choi, Uijeongbu-si (KR); Kil Koang Kwon, Seoul (KR)

Correspondence Address: Nixon Peabody LLP, 200 Page Mill Road, Suite 200, Palo Alto, CA, 94306, US

(21) Appl. No.: 12/025,058

(22) Filed: Feb. 4, 2008

(30) Foreign Application Priority Data
Dec. 31, 2007 (KR) 10-2007-0141801

(51) Int. Cl. H02J 3/00

(52) U.S. Cl. 191/2

(57) ABSTRACT

Provided are a tunnel type power generating apparatus and a method of generating power using the same capable of converting residual kinetic energy caused by movement of vehicles into electric energy and storing the converted electric energy to be used. The tunnel type power generating apparatus includes: a magnetic body selectively attached to an upper part or a lower part of a vehicle; a tunnel type coil formed of a conductive coil wound several times in one direction to generate induced current when the magnetic body passes therethrough; and a case into which the tunnel type coil is inserted, absorbing impact applied by a vehicle load to prevent damage to the tunnel type coil, and having a size corresponding to a road width.

This application claims the benefit of Korean Application Nos. P2007-0141801, which was filed on Dec. 31, 2007, which is hereby incorporated by reference as if fully set forth herein.

### BACKGROUND OF THE INVENTION

1. Field of the invention

The present invention relates to a tunnel type power generating apparatus and a method of generating power using the same, and more particularly, to a tunnel type power generating apparatus and a method of generating power using the same, capable of converting residual kinetic energy caused by movement of vehicles into electric energy and storing the converted electric energy to be used.

2. Description of the Related Art

In general, a power generating apparatus as a rotary power generator is classified into a rotating field magnet type or a rotating armature type. The rotary power generator has an induced current electromotive force in proportion to sin θ, and includes mechanical members such as an iron core, a slip ring, a brush, and so on as essential components.

In addition, a power generating apparatus using straight movement, rather than rotary movement, has been put to practical use as a small power generator having a relatively simple structure for generating an induced current electromotive force.

In this small power generator, a permanent magnet is inserted into a pipe passing through the interior of a fixed coil to reciprocate in the pipe, and both ends of the pipe are alternately inclined. When a front part of the permanent magnet passes through the coil, a positive induced current is generated, and when a rear part of the permanent magnet passes through the coil, a negative induced current is generated.

That is, when the front part and the rear part of the permanent magnet pass through the coil, induced currents opposite to each other are generated from the coil.

As described above, the power generating apparatus is provided to obtain high efficiency energy using residual kinetic energy such as wind power, in comparison with electric energy obtained using fuel, and so on.

In recent times, power generating apparatuses have been developed for converting residual kinetic energy generated by, for example, wind power and movement of vehicles, into electric energy.

Moreover, nowadays, since resources such as coal, petroleum, and so on, are being over-used and alternative energy is urgently required, it is important to maximize energy use efficiency of the available resources.

Therefore, development of a power generating apparatus capable of converting residual kinetic energy necessarily generated by movement of vehicles into electric energy and remarkably increasing conversion efficiency to electric energy is still needed.

### SUMMARY OF THE INVENTION

An object of the present invention is to provide a tunnel type power generating apparatus and a method of generating power using the same capable of converting residual kinetic energy generated by movement of vehicles into electric energy and storing the converted electric energy to be used, by providing a magnetic body attached to a vehicle and the tunnel type power generating apparatus selectively installed at a road.

An aspect of the invention provides a tunnel type power generating apparatus including: a magnetic body selectively attached to an upper part or a lower part of a vehicle; a tunnel type coil formed of a conductive coil wound several times in one direction to generate induced current when the magnetic body passes therethrough; and a case into which the tunnel type coil is inserted, absorbing impact applied by a vehicle load to prevent damage to the tunnel type coil, and having a size corresponding to a road width.

At this time, the tunnel type power generating apparatus may further include a power storage device provided at one side of the case, connected to both ends of the tunnel type coil, and storing induced current generated when the magnetic body passes through the tunnel type coil.

In addition, the case may include a lower case corresponding to a road width and an upper case connected to an upper part of the lower case to surround the entire outer part of the tunnel coil and to prevent moisture from being in contact with the tunnel type coil.

Further, the case may include inclined parts formed at front and rear sides of an upper surface of the case of the tunnel type power generating apparatus, and gentle projections formed at one surface of the case such that insertion parts of the tunnel type coil have a shape corresponding to an outer periphery of the tunnel type coil, to prevent vibration from the vehicle due to a height difference between the road and the upper surface of the case.

Meanwhile, the case may include an illumination device installed over an inner part of the case, and the power storage device may include a controller connected to an internal or external illumination device to supply the stored current to the internal or external illumination device and controlling the internal and external illumination devices.

In addition, the case may include a shock absorbing member disposed at parts of the case, into which the tunnel type coil is inserted, and surrounding an outer periphery of the tunnel type coil, to prevent damage to the tunnel type coil due to an external load.

Another aspect of the invention provides a method of generating power using a tunnel type power generating apparatus including: a first step of selectively attaching a magnetic body to an upper or lower part of a vehicle; a second step of passing the vehicle, on which the magnetic body is selectively attached to the upper or lower part, through the tunnel type power generating apparatus; and a third step of storing induced current generated from a tunnel type coil inserted into a case of the tunnel type power generating apparatus in a power storage device installed at one side of the tunnel type power generating apparatus.

At this time, in the second step, the case may function to absorb shock to prevent damage to the tunnel type coil due to a load of the vehicle when the vehicle passes through the case of the tunnel type power generating apparatus into which the tunnel type coil is inserted, and the vehicle may pass through the tunnel type coil via inclined parts installed at front and rear sides of an upper surface of the case of the tunnel type power generating apparatus to prevent vibration from the vehicle due to a height difference between the road and the upper surface of the case.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a tunnel type power generating apparatus in accordance with an exemplary embodiment of the present invention;

FIG. 2 is a cross-sectional view taken along line A-A of FIG. 1;

FIG. 3 is a perspective view of a tunnel type power generating apparatus in accordance with another exemplary embodiment of the present invention;

FIG. 4 is a cross-sectional view taken along line B-B of FIG. 3;

FIG. 5 is a perspective view of a tunnel type power generating apparatus in accordance with a first exemplary experiment of the present invention;

FIG. 6 is a perspective view of a tunnel type power generating apparatus in accordance with a second exemplary experiment of the present invention; and

FIG. 7 shows the results of the first and second experiments of the tunnel type power generating apparatus of the present invention.

### DETAILED DESCRIPTION OF EXEMPLARY EMBODIMENTS

Hereinafter, exemplary embodiments of the present invention will be described with reference to the accompanying drawings. In the following description, like reference numerals designate like elements throughout the specification and descriptions thereof will not be repeated.

Hereinafter, a tunnel type power generating apparatus and a method of generating power using the same in accordance with an exemplary embodiment of the present invention will be described with reference to the accompanying drawings.

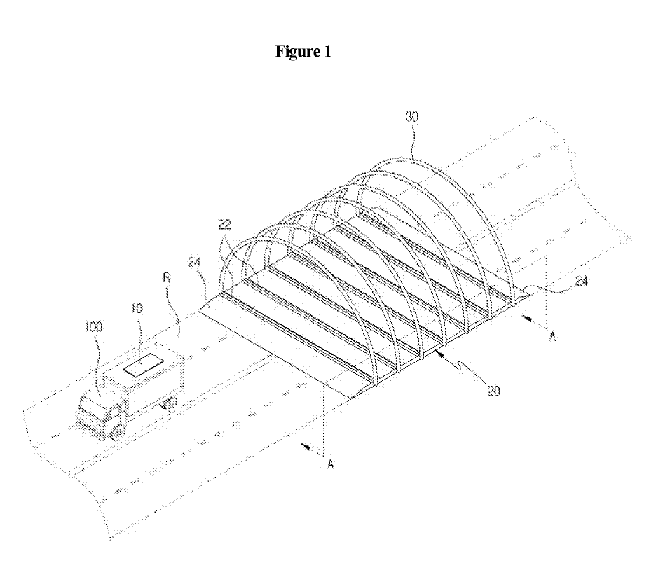

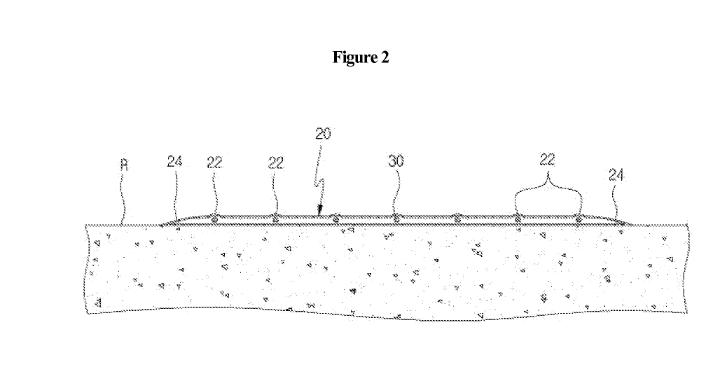

FIG. 1 is a perspective view of a tunnel type power generating apparatus in accordance with an exemplary embodiment of the present invention, and FIG. 2 is a cross-sectional view taken along line A-A of FIG. 1.

As shown in FIGS. 1 and 2, the tunnel type power generating apparatus in accordance with an exemplary embodiment of the present invention includes a magnetic body 10, a tunnel type coil 30, and a case 20.

Here, the magnetic body 10 is selectively attached to an upper or lower part of a vehicle 100, such as a conventional car, a truck, a bus, or the like.

At this time, the magnetic body 10 may be attached to a hood of the vehicle 100 when the magnetic body 10 is attached to the upper part of the vehicle 100.

In particular, in the case of the truck, the magnetic body 10 may be attached to a ceiling part thereof. When the magnetic body 10 is attached to the lower part of the vehicle, the magnetic body 10 may be attached to a predetermined part of a wheel to which a tire is attached or a predetermined position of a bottom surface of a lower part of the vehicle.

Moreover, the magnetic body 10 may be formed of a permanent magnet, or an electromagnet.

Here, when the magnetic body 10 is formed of an electromagnet, since the electromagnet is magnetized when electricity is applied thereto, a sensor (not shown) is attached to the electromagnet (not shown) to prevent unnecessary consumption of electricity.

At this time, the electromagnet may be magnetized when the sensor detects that the vehicle 100 is adjacent to the tunnel type coil.

In addition, the tunnel type coil 30 may be formed of a conductive coil wound several times in one direction to generate induced current when the vehicle 100 having the magnetic body 10 passes therethrough.

Further, the tunnel type coil 30 extends from both ends thereof to a predetermined length to store the generated induced current.

As described above, the both ends extending from the tunnel type coil 30 are connected to a power storage device (not shown) to store the generated induced current.

Meanwhile, the tunnel type coil 30 is partially inserted into the case 20, and the other part of the tunnel type coil 30 has a semi-cylindrical shape or a rectangular shape using its rigidity, similar to a conventional tunnel.

In addition, the case 20 has a horizontal part corresponding to a width of a road R, and the portion of the tunnel type coil 30 is inserted into the horizontal part to absorb a load of the vehicle 100 and to protect the tunnel type coil 30 from wheel friction of the vehicle 100.

At this time, the case 20 may have inclined parts 24 gently inclined at front and rear sides of an upper surface of the case 20 to prevent vibration from the vehicle 100 due to a height difference between the road R and the upper surface of the case 20.

Therefore, it is possible to prevent the vehicle 100 from being oscillated when the vehicle 100 enters the case 20 from the road R or leaves the case 20 to the road R.

In addition, the case 20 has gentle projections 22 formed at its upper surface and having a shape corresponding to an outer periphery of the tunnel type coil inserted into the case 20.

As described above, since the projections 22 have a smooth inclination angle, it is possible to slightly suppress generation of vibration from the vehicle 100 when the vehicle 100 passes therethrough.

In addition, the case 20 may include a shock absorbing member (not shown) disposed at the insertion parts thereof, into which the tunnel type coil 30 is inserted, and surrounding the outer periphery of the tunnel type coil 30, to prevent damage to the tunnel type coil 30 due to an external load, such as a load of the vehicle 100.

At this time, the shock absorbing member may be configured to surround the outer periphery of the tunnel type coil, and may be disposed inside the projections 22 of the case 20.

Meanwhile, the tunnel type power generating apparatus may further include a power storage device (not shown) connected to the extended both ends of the tunnel type coil 30 to store induced current generated when the vehicle 100 having the magnetic body 10 passes through the case 20 in which a portion of the tunnel type coil 30 is inserted.

Here, the power storage device may be installed at one side of the road R at which the tunnel type power generating apparatus is installed, and may be disposed under the case 20 and buried in the road R.

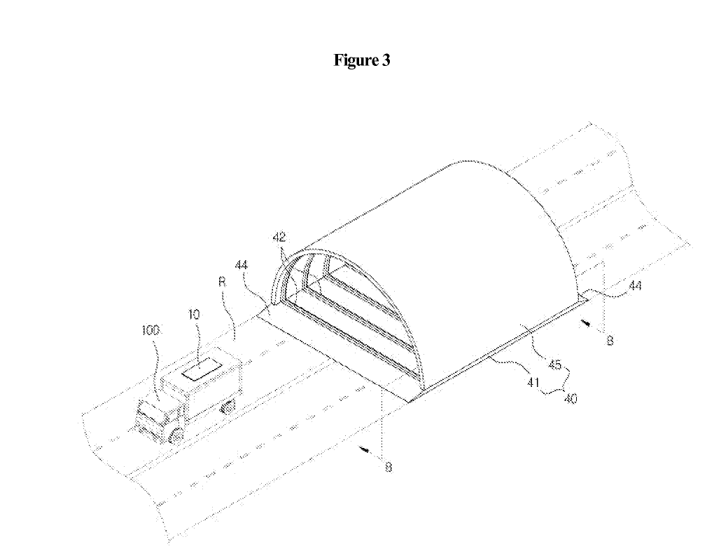

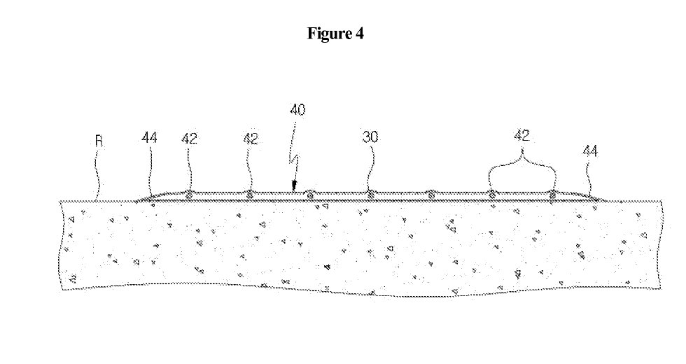

FIG. 3 is a perspective view of a tunnel type power generating apparatus in accordance with another exemplary embodiment of the present invention, and FIG. 4 is a cross-sectional view taken along line B-B of FIG. 3.

As shown in FIGS. 3 and 4, the tunnel type power generating apparatus in accordance with an exemplary embodiment of the present invention includes a magnetic body 10, a tunnel type coil 30, and a case 40.

Here, the magnetic body 10 is selectively attached to an upper or lower part of a vehicle 100 such as a conventional car, a truck, a bus, or the like.

At this time, the magnetic body 10 may be attached to a hood of the vehicle 100 when the magnetic body 10 is attached to the upper part of the vehicle 100. In particular, in the case of the truck, the magnetic body 10 may be attached to a ceiling part thereof. When the magnetic body 10 is attached to the lower part of the vehicle, the magnetic body 10 may be attached to a predetermined part of a wheel to which a tire is attached or a predetermined position of a bottom surface of a lower part of the vehicle.

Moreover, the magnetic body 10 may be formed of a permanent magnet, or an electromagnet.

When the magnetic body 10 is formed of an electromagnet, since the electromagnet is magnetized when electricity is applied thereto, a sensor (not shown) is attached to the electromagnet (not shown) to prevent unnecessary consumption of electricity such that the electromagnet can be magnetized when the sensor detects that the vehicle 100 is adjacent to the tunnel type coil.

In addition, the tunnel type coil 30 may be formed of a conductive coil wound several times in one direction to generate induced current when the vehicle 100 having the magnetic body 10 passes therethrough.

Further, the tunnel type coil 30 extends from both ends thereof to a predetermined length to store the generated induced current, and at this time, the both ends extending from the tunnel type coil 30 may be connected to a power storage device (not shown) to store the generated induced current.

Meanwhile, the tunnel type coil 30 is inserted into the case 40 such that the winding shape of the tunnel type coil 30 configures a conventional tunnel shape such as a semi-cylindrical shape or a rectangular shape, wherein the case 40 is comprised of an upper case 45 and a lower case 41.

As described above, the case 40 is configured to surround the entire outer part of the tunnel type coil 30 to prevent moisture from being in contact with the tunnel type coil 30.

Further, the case 40 as described above includes the upper case 45 and the lower case 41, wherein the upper case 45 has a semi-cylindrical shape or a rectangular shape, and the lower case 41 has a width corresponding to the width of the road R and is connected to lower parts of the upper case 45.

At this time, the upper case 45 may be fastened to the lower case 41 by predetermined fastening members (not shown), or the upper case 45 may be integrally formed with the lower case 41.

Meanwhile, the lower case 41 may have inclined parts 44 gently inclined at front and rear sides of the lower case 41 to prevent vibration from the vehicle 100 due to a height difference between the road R and the upper surface of the case 41.

Therefore, it is possible to prevent the vehicle 100 from being oscillated when the vehicle 100 enters the case 20 from the road R or leaves the case 20 to the road R.

In addition, the case 40 has gentle projections 42 such that the insertion parts of the tunnel type coil 30 have a shape corresponding to an outer periphery of the tunnel type coil 30. Specifically, the lower case 41 of the case 40 may have the projections 42, and the upper case 45 may not have the projections 42.

As described above, since the projections 42 have a smooth inclination angle, it is possible to slightly suppress generation of vibration from the vehicle 100 when the vehicle 100 passes therethrough.

In addition, the case 40 may include a shock absorbing member (not shown) disposed at the insertion parts thereof, into which the tunnel type coil 30 is inserted, and surrounding the outer periphery of the tunnel type coil 30, to prevent damage to the tunnel type coil 30 due to an external load, such as a load of the vehicle 100.

At this time, the shock absorbing member may be configured to surround the outer periphery of the tunnel type coil 30, and may be disposed inside the projections 42 of the case 40.

Meanwhile, the tunnel type power generating apparatus may further include a power storage device (not shown) connected to the extended both ends of the tunnel type coil 30 to store induced current generated when the vehicle 100 having the magnetic body 10 passes through the case 40 in which the tunnel type coil 30 is inserted.

Here, the power storage device may be installed at one side of the road R at which the tunnel type power generating apparatus is installed, and may be disposed under the case 40 and buried in the road R.

In addition, an illumination device (not shown) may be installed at an inner upper part of the case 40, and the power storage device may include a controller (not shown) connected to an internal or external illumination device (not shown) to supply the stored current to the internal or external illumination device and to control the internal and external illumination devices.

At this time, the internal illumination device (not shown) is referred to as an illumination device for a tunnel installed in a conventional tunnel, and the external illumination device (not shown) is referred to as an illumination device such as a street lamp, and so on, installed at the road side.

Meanwhile, a method of generating power using the tunnel type power generating apparatus in accordance with the present invention as described above includes the following steps.

First, a magnetic body is selectively attached to an upper part or lower part of a vehicle (Step 1)

Then, the vehicle, on which the magnetic body is selectively attached to the upper part or the lower part, passes through the tunnel type power generating apparatus (Step 2).

In addition, induced current generated from a tunnel type coil inserted into a case of the tunnel type power generating apparatus is stored in a power storage device installed at one side of the tunnel type power generating apparatus (Step 3).

Through Steps 1 to 3 as described above, it will be appreciated that electric power can be generated using the tunnel type power generating apparatus in accordance with the present invention, and the power generated therethrough can be stored.

Meanwhile, in Step 2, when the vehicle passes through the case of the tunnel type power generating apparatus into which the tunnel type coil is inserted, the case functions to absorb shock to prevent damage to the tunnel type coil due to a load of the vehicle.

Further, in Step 2, the vehicle passes along inclined parts installed at front and rear sides of an upper surface of the case of the tunnel type power generating apparatus from the road to prevent vibration from the vehicle being generated due to a height difference between the road and the upper surface of the case.

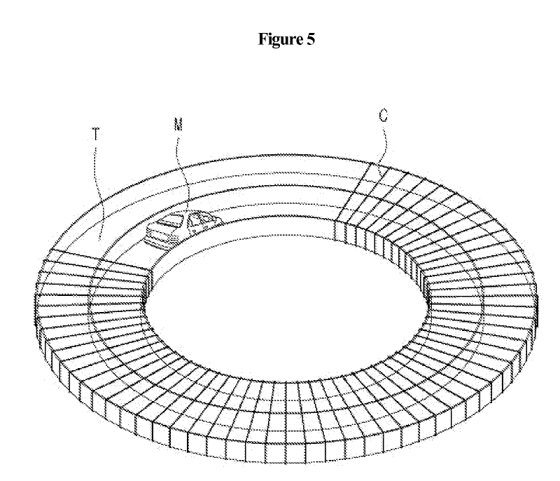

Hereinafter, experiments in which induced current is generated through the tunnel type power generating apparatus in accordance with the present invention will be described with reference to FIGS. 5 to 7, and the theory of generating induced current is performed according to Faraday's Law.

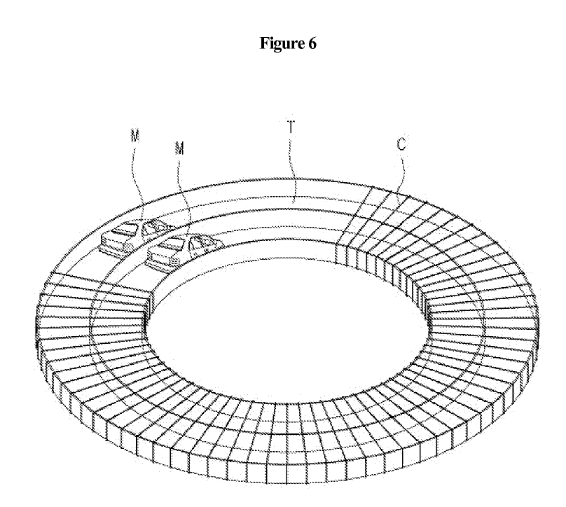

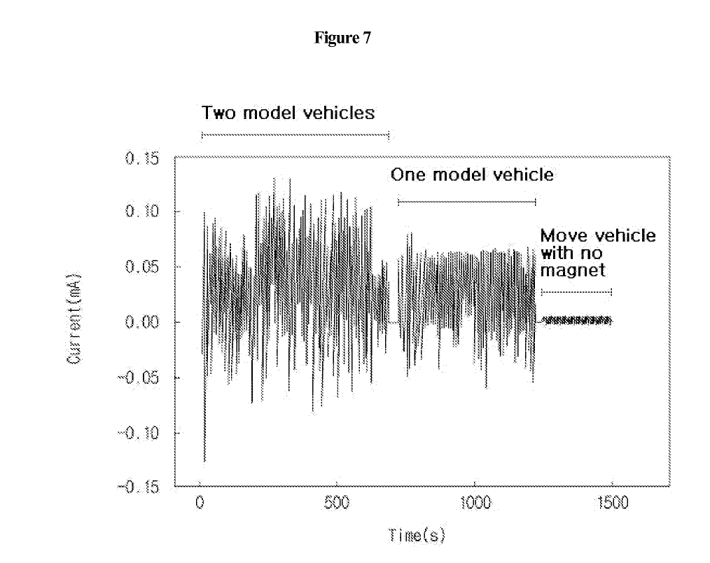

FIG. 5 is a perspective view of a tunnel type power generating apparatus in accordance with a first exemplary experiment of the present invention, FIG. 6 is a perspective view of a tunnel type power generating apparatus in accordance with a second exemplary experiment of the present invention, and FIG. 7 shows the results of the first and second experiments of the tunnel type power generating apparatus of the present invention.

As shown in FIGS. 5 to 7, an experimental set of the tunnel type power generating apparatus in accordance with the present invention includes a model car M having a permanent magnet attached thereto, a track T, and a coil C. The coil C is wound on a predetermined section of the track T in a tunnel shape.

Then, two model cars M having permanent magnets passed through the track T on which the coil C is wound, then, one model car M having a permanent magnet passed through the track T on which the coil C is wound, and finally, a model car M with no magnet passed through the track T on which the coil C is wound. (See FIGS. 5 and 6)

As can be seen from the graph of FIG. 7 showing results from the experiments, the amount of current was in proportion to the number of model cars having the magnets.

In addition, the model car having no magnet generated little current.

Therefore, it will be appreciated that the tunnel type power generating apparatus in accordance with the present invention can generate induced current and store electric power.

Meanwhile, it is possible to convert residual kinetic energy into electric energy and use the electric energy through the tunnel type power generating apparatus and a method of manufacturing the same in accordance with the present invention as described with reference to FIGS. 1 to 7.

Therefore, the tunnel type power generating apparatus can be readily installed on a road such that current is generated through movement of magnet-attached vehicles, stored and used for various purposes.

In addition, by attaching the magnetic body to the vehicle moving on the road, the tunnel type power generating apparatus in accordance with the present invention can be used to measure speed of the vehicle and identify the vehicle using a particular electromotive force.

As can be seen from the foregoing, a tunnel type power generating apparatus and a method of generating power using the same in accordance with the present invention provide the following effects.

First, it is possible to convert residual kinetic energy due to movement of vehicles into electric energy by providing a tunnel type coil capable of generating induction current when a magnetic body attached to a vehicle passes through the tunnel type coil.

Second, by providing a power storage device, electric energy generated through the tunnel type coil can be stored in the power storage device. In addition, just after storing the energy or when necessary, the stored electric energy can be supplied to an external illumination device such as street lamps on the road or an internal illumination device in the tunnel type power generating apparatus.

Third, it is possible to detect a speed of the vehicle according to an induced electromotive force generated from the tunnel type coil when the vehicle having a magnet passes through the tunnel type coil.

Fourth, since the vehicle having a magnet passing through the tunnel type coil has a particular induced electromotive force generated from the tunnel type coil, it is possible to identify the vehicle by using the particular induced electromotive force.

While this invention has been described with reference to exemplary embodiments thereof, it will be clear to those of ordinary skill in the art to which the invention pertains that various modifications may be made to the described embodiments without departing from the spirit and scope of the invention as defined in the appended claims and their equivalents.

What is claimed is:

1. A tunnel type power generating apparatus comprising:
a magnetic body selectively attached to an upper part or a lower part of a vehicle;
a tunnel type coil formed of a conductive coil wound several times in one direction to generate induced current when the magnetic body passes therethrough; and
a case into which the tunnel type coil is inserted, absorbing impact applied by a vehicle load to prevent damage to the tunnel type coil, and having a size corresponding to a road width.

2. The tunnel type power generating apparatus according to claim 1, further comprising a power storage device provided at one side of the case, connected to both ends of the tunnel type coil, and storing induced current generated when the magnetic body passes through the tunnel type coil.

3. The tunnel type power generating apparatus according to claim 1, wherein the case comprises a lower case corresponding to a road width and an upper case connected to an upper part of the lower case to surround the entire outer part of the tunnel coil and to prevent moisture from being in contact with the tunnel type coil.

4. The tunnel type power generating apparatus according to claim 1, wherein the case comprises inclined parts formed at front and rear sides of an upper surface of the case and projections smoothly curved at one surface of the case such that insertion parts of the tunnel type coil have a shape corresponding to an outer periphery of the tunnel type coil, to prevent vibration from the vehicle due to a height difference between the road and the upper surface of the case.

5. The tunnel type power generating apparatus according to claim 2 further comprising an illumination device installed over an inner part of the case, wherein the power storage device comprises a controller connected to the illumination device to supply the stored current to the illumination device and controlling the illumination devices.

6. The tunnel type power generating apparatus according to claim 1, wherein the case comprises a shock absorbing member disposed at parts of the case, into which the tunnel type coil is inserted, and surrounding an outer periphery of the tunnel type coil, to prevent damage to the tunnel type coil due to an external load.

7. A method of generating power using a tunnel type power generating apparatus, comprising:
a first step of selectively attaching a magnetic body to an upper or lower part of a vehicle;
a second step of passing the vehicle, on which the magnetic body is selectively attached to the upper or lower part, through the tunnel type power generating apparatus; and
a third step of storing induced current generated from a tunnel type coil inserted into a case of the tunnel type power generating apparatus in a power storage device installed at one side of the tunnel type power generating apparatus.

8. The method according to claim 7, wherein, in the second step, the case functions to absorb shock to prevent damage to the tunnel type coil due to a load of the vehicle when the vehicle passes through the case of the tunnel type power generating apparatus into which the tunnel type coil is inserted, and the vehicle passes through the tunnel type coil via inclined parts installed at front and rear sides of an upper surface of the case of the tunnel type power generating apparatus to prevent vibration from the vehicle due to a height difference between the road and the upper surface of the case.
